(19) United States
(12) Patent Application Publication
(10) Pub. No.: US 2025/0066263 A1
(43) Pub. Date: Feb. 27, 2025

(54) Refractory Material with Supercritical Fluid-Deposited Interface Coatings

(71) Applicant: Raytheon Company, Waltham, MA (US)

(72) Inventor: James E. Foreman, Frisco, TX (US)

(21) Appl. No.: 18/455,568

(22) Filed: Aug. 24, 2023

(51) Int. Cl. C04B 41/45; C04B 35/76; C04B 41/00

(52) U.S. Cl. CPC C04B 41/4554; C04B 35/76; C04B 41/0072; C04B 41/4519; C04B 2235/5208; C04B 2235/6583

(57) ABSTRACT

A refractory material can include a refractory filament and an interface coating applied to the refractory filament. The interface coating can include a refractory metal or semi-metal oxide, metal or semi-metal nitride, metal or semi-metal carbide, metal or semi-metal oxynitride, metal or semi-metal carbonitride, and/or metal or semi metal oxycarbide formed by depositing an organometallic precursor onto the refractory filament by supercritical fluid deposition and heat treating the organometallic precursor in the presence of an atmospheric condition so that the organometallic precursor forms an interface coating that is an oxidized, pyrolyzed, or carbidized form of the organometallic precursor and is present at a surface and beneath the surface of the refractory filament.

### BACKGROUND

Ceramic matrix composite (CMC) material can be prepared by compositing a ceramic material with a broadgood (or fabric), which may be useful in a variety of industries, including for the formation of radomes (e.g., structural enclosure to protect antennas that is typically transparent to radio waves), nuclear energy components, fusion or fission reactors, jet engine or gas turbine components, aerospace components, environmental barrier coatings, friction systems (e.g., brakes, slide bearings, etc.), high temperature chambers (e.g., ovens, furnaces, kilns, incinerators, etc.), power generation equipment, or other structures in need of enhanced temperature, chemical, and/or mechanical resistance, toughness, or durability properties. Preparation of the broadgood may include combining refractory filament into small clusters to form a rope-like structure referred to as “fiber” or “tow,” e.g., twisted, braided, gathered, etc. The tow may then be used to form the broadgood, which may be woven, unwoven, stitched, etc. An interface coating is typically applied to the filament, tow, or broadgood prior to compositing with the ceramic, and in many instances, promotes wetting and infiltration of the ceramic material and/or prevents damage to the filament.

### BRIEF DESCRIPTION OF THE DRAWINGS

FIG. 1 illustrates an example treated refractory filament with an interface coating surrounding a surface of the refractory filament in accordance with the present disclosure.

FIG. 2 illustrates example tow bundled together with treated refractory filaments in accordance with the present disclosure.

FIG. 3 illustrates an example woven broadgood of tow that includes treated refractory filaments in accordance with the present disclosure.

FIG. 4 illustrates an example ceramic matrix composite of broadgood that includes treated refractory filaments in accordance with the present disclosure.

FIG. 5 is a flow chart illustrating an example method of making refractory material in accordance with the present disclosure.

### DETAILED DESCRIPTION

In accordance with the present disclosure, a treated refractory material can include treated refractory filaments with interface coatings, and can be in the form of an individual treated refractory filament, tow with treated refractory filaments, or broadgood with treated refractory filaments. The interface coating can include a refractory metal or semi-metal oxide, metal or semi-metal nitride, metal or semi-metal carbide, metal or semi-metal oxynitride, metal or semi-metal carbonitride, metal or semi metal oxycarbide, or a combination thereof, which may be formed by depositing an organometallic precursor onto the refractory filament by supercritical fluid deposition and heat treatment of the organometallic precursor applied to the refractory fiber in the presence of an atmospheric condition arranged so that the organometallic precursor forms an interface coating that is an oxidized, pyrolyzed, or carbidized form of the organometallic precursor and is present at a surface and surrounding, the surface of the refractory filament.

In another example, a ceramic matrix composite can comprise a refractory material, including a plurality of refractory filaments assembled together in the form of a broadgood, and an interface coating applied to the plurality of refractory filaments. The interface coating can include a refractory metal or semi-metal oxide, metal or semi-metal nitride, metal or semi-metal carbide, metal or semi-metal oxynitride, metal or semi-metal carbonitride, metal or semi metal oxycarbide, or a combination thereof, which can be formed by depositing an organometallic precursor onto the refractory filament by supercritical fluid deposition, and heat treating the organometallic precursor in the presence of an atmospheric condition configured so that the organometallic precursor becomes oxidized, pyrolyzed, or carbidized and is present at and beneath a surface of the refractory filament. The ceramic matrix composite can also include a ceramic material composited with and encapsulating at least a portion of the broadgood.

In another example, a method of making refractory material can include depositing an organometallic precursor onto a refractory filament via supercritical fluid deposition, and heat treating the refractory filament including the organometallic precursor deposited thereon under atmospheric conditions to oxidize, pyrolyze, or carbidize the organometallic precursor at and beneath a surface of the refractory filament. Heating, for example, causes the organometallic precursor to form a metal or semi-metal oxide, metal or semi-metal nitride, metal or semi-metal carbide, metal or semi-metal oxynitride, metal or semi-metal carbonitride, metal or semi metal oxycarbide, or a combination thereof surrounding the surface of the refractory filament.

As a note, with respect to the refractory materials, the ceramic matrix composites, and the methods of making refractory materials described herein, specific descriptions with respect to one example can be considered applicable to other examples whether or not they are explicitly discussed in the context of that example. Thus, for instance, in discussing a refractory filament related to the refractory materials, such disclosure is also relevant to and directly supported in context of the ceramic matrix composites and the methods, and vice versa.

The terms used herein will have their ordinary meaning in the relevant technical field unless specified otherwise. In some instances, there are terms defined more specifically throughout the specification, with a few more general terms included at the end of the specification. These more specifically defined terms have the meaning as described herein.

The term “treated refractory material” refers to any of a number of structures, including treated refractory filaments, tow that includes treated refractory filaments, broadgood (or fabric) including treated refractory filaments, or ceramic matrix composites that include treated refractory filaments (or tow or broadgood from treated refractory filaments).

In accordance with the present disclosure, a “treated refractory filament” includes a refractory filament that is coated so as to be surrounded by an interface coating, and more specifically, an interface coating applied using supercritical fluid deposition followed by heat treatment. In some instances, the refractory filament may be partially infiltrated by the interface coating, e.g., up to about 20% or up to about 10% of a cross-sectional diameter of the refractory filament.

“Tow” and “fiber” are used synonymously herein and refer to small clusters of treated refractory filaments that are aligned, gathered, clustered, braided, twisted, untwisted, spun, etc., along their z-axis (the elongated axis of the fiber).

“Broadgood” refers to fabrics that include treated refractory filaments, typically from tow but in some instances, directly using refractory filament. The treated refractory filament can be coated to surround a surface of the individual refractory filament, as tow, or as broadgood. Broadgood may be woven (bi-directional, unidirectional, etc.) or nonwoven (matted, discontinuous, pressed, etc.).

“Ceramic matrix composite” refers to composites of ceramic material partially or fully encapsulating a treated refractory material, which is typically in the form of broadgood.

The terms “refractory” and “refractories” refer to materials that are resistant to decomposition by heat, pressure, or chemical attack, and furthermore, retain their strength and form under high temperatures, for example. Refractories also tend to be polycrystalline, polyphase, inorganic, non-metallic, porous, and heterogeneous. Examples include oxides, nitrides, carbides, etc., of silicon, aluminum, magnesium, calcium, boron, chromium, zirconium, etc. ASTM C71 defines refractories as “non-metallic materials having those chemical and physical properties that make them applicable for structures, or as components of systems, that are exposed to environments above 1,000° F. (811 K; 538° C.).”

The term “organometallic precursor(s)” includes organics combined with either metals or semi-metals as the precursor. For example, silicon oxynitride pre-polymer is considered an organometallic precursor that can be used to form a silicon nitride interface coating; hafnium acetate (or other carboxylate) is an organometallic precursor that can be used to form hafnium oxide, nitride, or carbide; tantalum acetate (or other carboxylate is an organometallic precursor that can be used to form tantalum oxide, nitride, or carbide; etc.

Refractory filaments, such as those typically used in the generation of ceramic matrix composites (CMC), may or may not include interface coatings. If applied, such as to prevent mechanical clamping of ceramic material onto the refractory filament and/or provide chemical resistance from the ceramic material when composited, various methodologies of application of the interface coatings may be susceptible to failure. For example, methods for applying interface coatings to refractory filaments may occur at the individual filament level or may occur after preparation of tow or broadgood from the refractory filament. Application may be achieved by mechanically spreading interface coating material to the tow or broadgood, e.g., submersing in a molten bath or chemical vapor infiltration (CVI), chemical vapor deposition (CVD), atomic layer deposition (ALD), etc. These processes can be very time consuming, expensive, and often not typically effective with respect to one or more type of durability, e.g., mechanical, chemical, temperature, etc. Furthermore, when applying the interface coating after preparing the tow and/or the broadgood, “shadowing” of fibers from other more outwardly-positioned fibers can prevent ingression of the coating in localized areas such that sufficiently uniform coating may not be able to be obtained.

In accordance examples of the present disclosure, by applying interface coatings using supercritical fluid deposition (under pressure), a more uniform interface coating can be applied that more fully surrounds the refractory filaments. This may occur when applying the interface coating to individual refractory filament, tow (of multiple refractory filaments), or broadgood. Table 1 below provides some example compounds which can be processed to form supercritical fluids in accordance with the present disclosure.

TABLE 1
Compounds for Form Supercritical Fluids

| | Molecular | Critical | Critical | Critical |
|---|---|---|---|---|
| | Mass | Temperature | Pressure | Density |
| Solvent | g/mol | K | MPa (atm) | g/cm³ |
| Carbon Dioxide | 44.01 | 304.1 | 7.38 (72.8) | 0.469 |
| Water | 18.02 | 647.1 | 22.06 (217.8) | 0.322 |
| Methane | 16.04 | 190.4 | 4.60 (45.4) | 0.162 |
| Ethane | 30.07 | 305.6 | 4.87 (48.1) | 0.203 |
| Propane | 44.09 | 369.8 | 4.25 (41.9) | 0.217 |
| Ethylene | 28.05 | 282.4 | 5.04 (49.7) | 0.215 |
| Propylene | 42.08 | 364.9 | 4.60 (45.4) | 0.232 |
| Methanol | 32.04 | 512.6 | 8.09 (79.8) | 0.272 |
| Ethanol | 46.07 | 513.9 | 6.14 (60.6) | 0.276 |
| Acetone | 58.08 | 508.1 | 4.70 (46.4) | 0.278 |
| Nitrous Oxide | 44.01 | 306.6 | 7.35 (72.5) | 0.452 |

In accordance with this, an organometallic precursor as described herein can be put into a supercritical solution, and the dissolved or dispersed organometallic precursor can be deposited on to the refractory filament while being carried by the supercritical solution. The use of such supercritical deposition can be beneficial as it exhibits almost no surface tension during application of the organometallic precursor to the refractory filament. Thus, the supercritical solution tends to more fully wet the surface of the refractory filament. This enables a more complete application of the organometallic precursor to the refractory filament surfaces, even if already formed as a tow or even as broadgood in some instances. Furthermore, the increased pressure that is present tends to push the organometallic precursor beneath the surface of the refractory filaments that are present in the supercritical solution. The upper concentration of the organometallic precursor that may be dissolved or dispersed effectively may also be limited by its solubility in the compound in the supercritical state. In some instances, a co-solvent may be also included to assist with dissolving the organometallic precursor. In some examples and without being limiting, there may be a minimum concentration of organometallic precursor that is desired for a given application, e.g., from 0.001 M to 0.1 M or from 0.005 M to 0.05 M.

When applying the organometallic precursor (carried by the supercritical fluid) to the refractory filament, in some instances, it may take a matter of minutes to effectively coat the organometallic precursor on the surface, and in some instances, partially infiltrate the refractory filament just beneath the surface, e.g., from 3 minutes to 2 hours or from 5 minutes to 1 hours. In some examples, the refractory filament could be drawn through the supercritical fluid carrying the organometallic precursor at a rate appropriate for the materials chosen for use, e.g., at a specific rate per minute based on the refractory filament, supercritical fluid, and organometallic precursor chosen. As the supercritical fluid used may be held at multiple atmospheres of pressure during processing, the supercritical fluids carrying the organometallic precursor can exhibit sufficient diffusivity to partially infiltrate the refractory filaments in some instances. Once the refractory filament has been coated by the organometallic precursor by supercritical deposition, and in some instances partially infiltrated at a depth of up to 10% or up to 20% of the x-y cross-sectional diameter, the organometallic precursor can be post-processed to convert the organometallic precursor to an interface coating that includes a refractory metal or semi-metal oxide, metal or semi-metal nitride, metal or semi-metal carbide, metal or semi-metal oxynitride, metal or semi-metal carbonitride, metal or semi metal oxycarbide, or a combination thereof. The conversion process may include the application of heat, and in some instances pressure, as described in greater detail hereinafter.

The process of application of the interface coating using supercritical fluid deposition of organometallic precursor followed by heat (and pressure in some instances) can be repeated to apply additional layers of the interface coating. The additional coatings may or may not infiltrate the treated refractory filaments as thoroughly, but additional layers of interface coating of the same or different materials can provided additional protection to the broadgood prior to forming a ceramic matrix composite. The single application of the interface coating or multiple applications of interface coatings may allow for tailoring the material for various applications, such as to provide enhanced chemical resistance, modified coefficient of friction, modified thermal conductivity, etc. The ability to tailor broadgood material to include multicomponent layered interface coatings may not be as readily achievable using conventional solvation approaches due to solubility characteristics of the materials that may otherwise be useful for application to refractory filament. Furthermore, by leveraging the enhanced solubility obtained using supercritical deposition, this process may also chemically strip any applied surfactants, sizing agents, finishing agents, etc., that were applied to the refractory filament, tow, or broadgood. Subjecting the refractory material to supercritical fluid conditions (during deposition or as a preliminary preconditioning step) may also reduce potential handling damage to the fabric.

### Treated Refractory Filaments

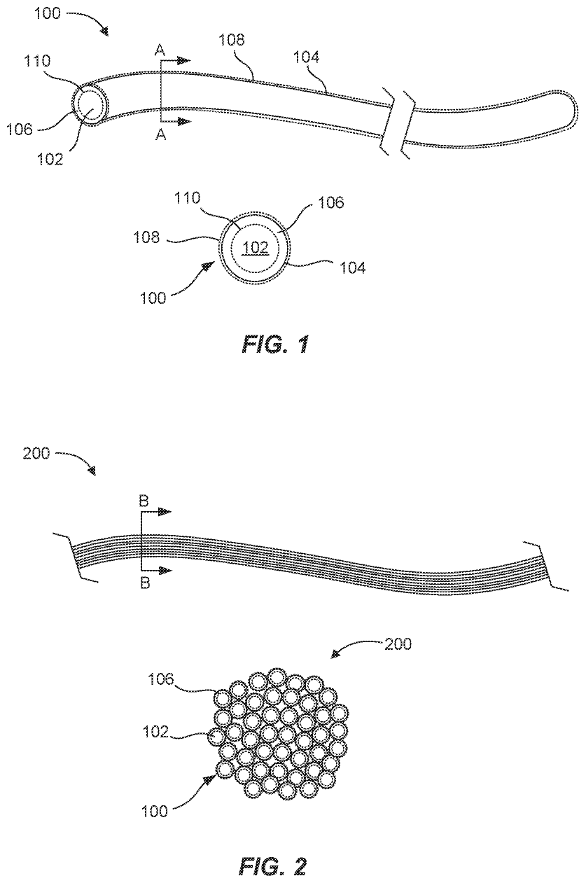

FIG. 1 illustrates an example treated refractory filament 100, which is shown in perspective along its elongated z-axis, as well as in x-y cross-section shown at A-A. In this example, the treated refractory filament includes a fiber filament 102 having a surface 104. The treated refractory filament includes an interface coating 106 that is present at the surface of the refractory filament, as illustrated at 108, but is also shown as penetrated beneath the surface of the refractory filament, as illustrated at 110. The interface coating may include a refractory metal or semi-metal oxide, metal or semi-metal nitride, metal or semi-metal carbide, metal or semi-metal oxynitride, metal or semi-metal carbonitride, and/or metal or semi metal oxycarbide which is formed by supercritical fluid deposition and heat treatment. For example, the supercritical fluid deposition or application can include depositing an organometallic precursor onto the refractory filament by supercritical fluid application for organometallic precursor infiltration. Heat treatment of the organometallic precursor upon application to the organometallic precursor in the presence of an atmospheric condition, e.g., elevated oxygen, nitrogen, ammonium, hydrogen, argon, vacuum, etc., can cause the organometallic precursor (applied using supercritical fluid deposition) to become oxidized, pyrolyzed, or carbidized both at and beneath the surface of the refractory filament, as shown in FIG. 1.

In some examples, the refractory filament 110 may be of a material selected from silica or quartz, e.g., Astroquartz, alumina, e.g., Nextel 610, alumina silica ceramic, e.g., Nextel 729, silicon carbide, e.g., Nicalon, alumina silica boria ceramic, e.g., Nextel 312, Nextel 440, etc., silicon boron nitride, silicon nitride, silicon metal oxycarbides, e.g., Tyranno fiber such as Si—Al—C—(O), Si—Ti—C—(O), Si—Zr—C—(O), etc., glass, e.g., E-glass, S-2 glass, etc., and/or boron. Example refractory filament may have an x-y cross-sectional diameter from about 2 microns to about 40 microns, from about 3 microns to about 20 microns, or from about 4 microns to about 15 microns.

The interface coating 106 may be applied to the refractory filament but does not typically add a significant thickness to the surface of the refractory filament. Thus, the x-y cross-sectional diameter after application of the interface coating may be comparable to that of the refractory filament prior to coating. Notably, the interface coating may infiltrate the refractory filament by penetration into the interstices on the refractory fiber, such as by surface wetting, e.g., filling submicron interstices, providing some depth of penetration into the material, etc. However, subsequent heat treatment may act to cause some dissolution into the surface of the filaments. Regardless of the mechanism, the combination of supercritical deposition and heat treatment leads to a highly uniform coating with good adherence, whether there is penetration into the fiber material itself and/or into the submicron interstices. For example, the interface coating may be present so that it completely surrounds the refractory filament, but in some instances, the interface coating can be found beneath the surface of the refractory filament at from greater than 0% up to 20% of the distance of the x-y cross-sectional diameter of the refractory filament. In further detail, the interface coating can be, for example, an oxide, nitride, or carbide of any of a number of metals or semi-metals, e.g., silicon, hafnium, tantalum, zirconium, titanium, tungsten, molybdenum, niobium, rhenium, lanthanides, or a combination thereof.

### Tow Including Treated Refractory Filaments

FIG. 2 illustrates an example of tow 200 prepared from a gathering of treated refractory filaments 100 prepared in accordance with that shown and described in FIG. 1. The tow is shown along its elongated z-axis, as well as in x-y cross-section at B-B. As mentioned, tow may be gathered, clustered, braided, twisted, or otherwise collected along its elongated z-axis. Tow may include from about 50 to several thousand filaments 102, e.g., about 50 to about 5,000, about 100 to about 3,000, etc. The interface coating 106 in this example may be applied at the individual refractory filament level (as shown in FIG. 1), or may be applied after the tow is formed (as shown in FIG. 2).

One of the advantages of application of the interface coating 106 to a refractory filament 102 using supercritical fluid deposition as described herein is that typically, the organometallic precursor under these conditions will be better solubilized or dispersed in the supercritical solution. Furthermore, under the pressure conditions used for supercritical fluid deposition, more of the organometallic precursor under pressure may become fully coated or in some instances partially infiltrated beneath the surface of the refractory filament. For example, in the presence of shadowing of some of the refractory filaments from other more outwardly positioned refractory filament of the tow may not be as impactful in preventing coating the inwardly positioned filament due to the presence and conditions of the supercritical fluid processing, which would provide for even more deeply positioned refractory filament fibers from being coated with the organometallic precursor. Thus, even after the formation of tow, a more complete coating of organometallic precursor will find its target often throughout the tow.

### Broadgood Including Treated Refractory Filaments or Tow

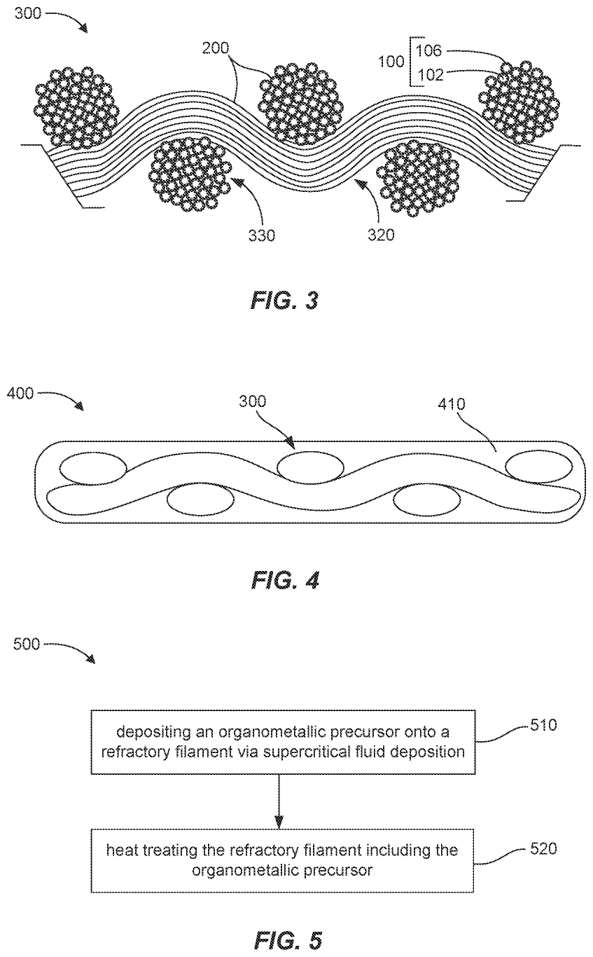

FIG. 3 illustrates an example of broadgood 300 prepared using tow 200, such as that described in FIG. 2 previously. Broadgood may be prepared using tow prepared from refractory filament, or in some instance may be prepared using refractory filament without first preparing tow. As shown, tow is woven together based on warp tow 320 and weft tow 330 (shown in cross-section).

Though the broadgood 300 is shown as being woven together, there are multiple weaves as well as other ways of preparing broadgood other than by that shown in FIG. 3. For example, broadgood can be prepared by bi-directional weaving (as shown), unidirectional weaving, braiding, or knitting. Broadgood can be either 2D or 3D. In other examples, broadgood can be nonwoven, with web structures that are matted, discontinuous, pressed, entangled, or bonded together via chemical, mechanical or heat treatment. The use of refractory filament (rather than tow) may be particularly useful in preparing nonwoven broadgood, though nonwoven broadgood can also be prepared using tow.

The application of an interface coating 106 to refractory filament 102 using supercritical fluid deposition may be particularly useful in the organometallic precursor application to individual refractory filament, even after the broadgood has been prepared. Under these conditions, the organometallic precursor may be better solubilized or dispersed in the supercritical solution. Furthermore, under the pressure conditions used for supercritical fluid deposition, more of the organometallic precursor under pressure may become more fully coated and in some instances partially infiltrated beneath the surface of the refractory filament. Furthermore, shadowing of refractory filament from other more outwardly positioned refractory filament of the tow or other more outwardly positioned refractory filaments may also come into contact with the supercritical fluid, thereby allowing even more deeply positioned refractory filament fibers from being coated with the organometallic precursor being carried by the supercritical fluid. Thus, even after the formation of broadgood, a more complete coating of organometallic precursor will find its target often throughout the broadgood.

Post-processing after Depositing Organometallic Precursor As described, the refractory filament can be coated with organometallic precursor as individual refractory filaments, as tow of refractory filaments, or as broadgood of refractory filaments. Once the refractory filament has been coated by the organometallic precursor by supercritical deposition, the organometallic precursor can be post-processed to convert the organometallic precursor to its metal or semi-metal carbide state. The conversion process may include the application of heat, e.g., in an oven or through a heating zone in a reel-to-reel process, under atmospheric conditions suitable to oxide, pyrolize, or carbidize the organometallic precursor as it sit on and within the refectory fiber. In some examples, this procedure could be carried out once, or could be carried out multiple times with the same organometallic precursor or a different organometallic precursor. The heat applied during the conversion process may be in the range of about 500° C. to about 1500° C.

Regarding the atmospheric conditions used to oxidize, pyrolize, nitride, or carbidize the organometallic precursor, typically the presence of oxygen leads to forming metal or semi-metal oxides, the presence of nitrogen leads to forming of metal or semi-metal nitrides, metal or semi-metal carbides, or metal or semi-metal carbonitrides, and the presence of vacuum pressure tends to lead to metal carbides. For example, in addition to the added heat, oxidation conversion atmospheric conditions may be ambient air, e.g., 20.95 vol % oxygen, or may include elevated oxygen levels, e.g., from above ambient to about 28 vol % oxygen, which is considered low level enrichment. On the other hand, in addition to heat, conversion to a nitride, a carbide, and/or a carbonitride may occur in atmospheric conditions containing nitrogen, e.g., N₂ atmosphere, NH₃/N₂ atmosphere, or H₂/N₂ atmosphere. Ratios of gases can be used based on modulating the amount of converted organometallic precursor, but in many instances, as much conversion of the organometallic precursor to the converted nitride and/or carbide may be particularly useful. For example, in the case of forming metal or semi-metal nitrides, an atmosphere if 80 vol % or greater of the N₂ gas can be present, while the other gas component, e.g., the NH₃ or H₂ can be present at a lesser concentration. On the other hand, if using closer to 100 vol % nitrogen gas (with trace amounts of other gases such as low O₂ content), the organometallic precursor would tend to form a metal carbide or semi-metal carbo-nitride on the surface of the refractory filaments.

### Ceramic Matrix Composites

Referring now to FIG. 4, broadgood 300 having an interface coating applied to the refractory filament may be composited with a ceramic material 410 to form a ceramic matrix composite 400. Prior to compositing, the broadgood (or refractory filament or tow) has been heat treated as described previously to form the interface coating at the refractory filament level. Thus, the ceramic matrix composite includes plurality of refractory filaments assembled together in the form of a broadgood with an interface coating applied to the plurality of refractory filaments. The interface coating in this example includes a refractory metal or semi-metal oxide, metal or semi-metal nitride, metal or semi-metal carbide, metal or semi-metal oxynitride, metal or semi-metal carbonitride, metal or semi metal oxycarbide, or a combination thereof, which can be formed by depositing an organometallic precursor onto the refractory filament by supercritical fluid deposition and heat treating the organometallic precursor in the presence of an atmospheric condition so that the organometallic precursor becomes oxidized, pyrolyzed, or carbidized and is present at and beneath a surface of the refractory filament. The refractory filaments in this example may include silica, alumina, silicon carbide, silicon oxycarbide, silicon oxy-nitrides, silicate glass, and boron, or a combination thereof; and the interface coating can include an oxide, nitride, or carbide of silicon, hafnium, tantalum, zirconium, titanium, tungsten, molybdenum, niobium, rhenium, lanthanides, or a combination thereof. In examples where partial infiltration of the refractory filament occurs, the interface coating may be present not only at the surface (typically fully coating the refractory filament), but as may be beneath the surface of the refractory filament at from greater than 0% up to 10% or greater than 0% up to 20% in distance based on an x-y cross-sectional diameter of the refractory filament. As an example, at 10%, infiltration of the interface coating may be present, on average, at 20% across a diameter of the refractory filament, as both ends of the diameter may be coated and infiltrated with the interface coating.

By depositing the interface coating using supercritical fluid deposition carrying organometallic precursor followed by heat treatment, the refractory filament may be highly protective for use in harsh environments. For example, the interface coating when applied and reacted to the refractory filament, tow or broadgood, may protect the reinforcement against chemical or thermal attack, or fiber clamping by the pre-ceramic polymer or ceramic binder infiltrate upon thermal conversion to the ceramic matrix composite (CMC). For example, the coated broadgood prepared as described provides extra protection from chemical and/or thermal attack when converting the pre-ceramic or sintering the ceramic material to form the ceramic composite matrix, as the pre-ceramic or ceramic material is typically converted or sintered at high temperatures, e.g., from about 500 C to about 1500 C.

Normally, by coating the outermost region of the broadgood rather than at a point in time prior to forming the broadgood, e.g., at the tow or the refractory filament stage, there may be some pathways for ceramic infiltration at high temperatures that remain. However, the use of supercritical deposition followed by heat as described herein provides a more complete refractory filament coating onto the interface coating, and thus can provide an advantage in the fabrication process.

### Methods of Making Refractory Materials

In further detail and in accordance with that described above, in some examples, methods 500 of making refractory material are shown at FIG. 5. The method can include depositing 510 an organometallic precursor onto a refractory filament via supercritical fluid deposition and heat 520 treating the refractory filament including the organometallic precursor deposited thereon under atmospheric conditions to oxidize, pyrolyze, or carbonize or nitride the organometallic precursor at and partially beneath a surface of the refractory filament to form an interface coating including refractory metal or semi-metal oxide, metal or semi-metal nitride, metal or semi-metal carbide, metal or semi-metal oxynitride, metal or semi-metal carbonitride, and/or metal or semi metal oxycarbide, which surrounds the surface of the refractory filament. In this example, the supercritical fluid used to carry the organometallic precursor to the refractory filament may be selected from carbon dioxide, methane, ethane, propane, ethylene, propylene, methanol, ethanol, acetone, or nitrous oxide, water, or ammonia. In other examples, the organometallic precursor can be a metal or semi-metal carboxylic acid, ester, ether, amides, aldehyde, ketone, organohalide, carboxylate, or a combination thereof.

Example atmospheric conditions that can be used after supercritical deposition of the organometallic precursor may include subjecting the refractory filament (or tow or broadgood) to elevated levels of oxygen, halogen, ammonia, hydrogen, nitrogen, argon or a combination thereof. To provide a few examples, the organometallic precursor may be a metal alkoxide, a metal halide, a metal alkyammonium, a metal carborane, a metal organosilane, a metal organosiloxane, or a combination thereof, and the atmospheric conditions may include elevated levels of oxygen, halogen, nitrogen, ammonium, vacuum pressure from about 0.01 psi to about 100 psi, or a combination thereof. In some examples, the metal of the organometallic precursor can include silicon, hafnium, zirconium, titanium, rhenium, tantalum, tungsten, niobium, or a combination thereof. In other examples, the metal or semi-metal oxide, metal or semi-metal nitride, metal or semi-metal carbide, metal or semi-metal oxynitride, metal or semi-metal carbonitride, and/or metal or semi metal oxycarbide that is formed may be present beneath the surface of the refractory filament at from greater than 0% up to 20% (or up to 10% of an x-y cross-sectional diameter of the refractory filament. The method may also include assembling the refractory filaments having metal or semi-metal oxide, metal or semi-metal nitride, metal or semi-metal carbide, metal or semi-metal oxynitride, metal or semi-metal carbonitride, and/or metal or semi metal oxycarbide to surround the surface of the refractory filaments to form tow, broadgood, or both. In other examples, the broadgood can be composited with and at least partially encapsulated with a ceramic material to form a ceramic matrix composite. The ceramic material, for example, can be selected from carbon, silicon carbide, alumina, mullite, silicon nitride, aluminum phosphates, barium aluminum silicate, preceramic polymers or a combination thereof. These and other methodologies can be incorporated or implement in forming treated refractory filaments including refractory filament with interface coating, tow including treated refractory filaments of refractory filament and interface coating, and/or broadgood including treated refractory filaments of refractory filament and interface coating as described.

In accordance with the present disclosure, it is noted that no specific order is required in the methods disclosed herein, though generally in some examples, method steps can be carried out sequentially. It is also understood that the examples set forth herein are not limited to the particular structures, process steps, or materials disclosed, but are extended to equivalents thereof as would be recognized by those ordinarily skilled in the relevant arts. It should also be understood that terminology employed herein is used for the purpose of describing particular examples only and is not intended to be limiting.

Furthermore, the described features, structures, or characteristics may be combined in any suitable manner in one or more examples. In the description, numerous specific details are provided, such as examples of lengths, widths, shapes, etc., to provide a thorough understanding of the technology being described. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts described herein. Accordingly, it is not intended that the invention be limited, except as by the claims set forth below.

What is claimed is:

1. A refractory material, comprising:
a refractory filament; and
an interface coating applied to the refractory filament, wherein the interface coating includes a refractory metal or semi-metal oxide, metal or semi-metal nitride, metal or semi-metal carbide, metal or semi-metal oxynitride, metal or semi-metal carbonitride, metal or semi metal oxycarbide, or a combination thereof, and is formed by: depositing an organometallic precursor onto the refractory filament by supercritical fluid deposition, and heat treating the organometallic precursor in the presence of an atmospheric condition so that the organometallic precursor forms an interface coating including an oxidized, pyrolyzed, or carbidized form of the organometallic precursor, wherein the interface coating surrounds a surface of the refractory filament.

2. The refractory material of claim 1, wherein the refractory filament is selected from quartz, silica, alumina, alumina silica ceramic, alumina silica boria, silicon carbide, silicon metal oxycarbide, silicon boron nitride, silicon nitride, glass, or a combination thereof.

3. The refractory material of claim 1, wherein the interface coating is an oxide, nitride, or carbide of silicon, hafnium, tantalum, zirconium, titanium, tungsten, molybdenum, niobium, rhenium, lanthanides, or a combination thereof.

4. The refractory material of claim 1, wherein the interface coating is present beneath the surface of the refractory filament at a distance from greater than 0% up to 20% of an x-y cross-sectional diameter of the refractory filament.

5. The refractory material of claim 1, wherein a plurality of the refractory filaments with the interface coating applied thereto are gathered together in the form of tow.

6. The refractory material of claim 5, wherein a plurality of tows or a plurality of treated refractory filaments are assembled in the form of broadgood.

7. A ceramic matrix composite, comprising:
a refractory material, including:
a plurality of refractory filaments assembled together in the form of a broadgood,
an interface coating applied to the plurality of refractory filaments, wherein the interface coating includes a refractory metal or semi-metal oxide, metal or semi-metal nitride, metal or semi-metal carbide, metal or semi-metal oxynitride, metal or semi-metal carbonitride, metal or semi metal oxycarbide, or a combination thereof formed by depositing an organometallic precursor onto the refractory filament by supercritical fluid deposition, and heat treating the organometallic precursor in the presence of an atmospheric condition so that the organometallic precursor becomes oxidized, pyrolyzed, or carbidized forming an interface coating that surrounds a surface of the refractory filament; and
a ceramic material composited with and encapsulating at least a portion of the broadgood.

8. The ceramic matrix composite of claim 7, wherein the plurality of refractory filaments are selected from quartz, silica, alumina, alumina silica ceramic, alumina silica boria, boron, silicon carbide, silicon oxycarbide, silicon boron nitride, silicon nitride, Si—Al—C—(O), Si—Ti—C—(O), Si—Zr—C—(O), glass, or a combination thereof; and wherein the interface coating is an oxide, nitride, or carbide of silicon, hafnium, tantalum, zirconium, titanium, tungsten, molybdenum, niobium, rhenium, lanthanides, or a combination thereof.

9. The ceramic matrix composite of claim 7, wherein the interface coating is present beneath the surface of the refractory filament at from greater than 0% up to 20% of an x-y cross-sectional diameter of the refractory filament.

10. The ceramic matrix composite of claim 7, plurality of refractory filaments are gat a plurality of the refractory filaments with the interface coating applied thereto are gathered together in the form a plurality of tows, and the tows are woven to form the broadgood, wherein the interface coating is applied to individual refractory filaments prior to forming the tow, to the plurality of refractory filaments after forming the tow, or to the plurality of refractory filaments after forming the broadgood.

11. A method of making refractory material, comprising:
depositing an organometallic precursor onto a refractory filament via supercritical fluid deposition; and
heat treating the refractory filament including the organometallic precursor deposited thereon under atmospheric conditions to oxidize, pyrolyze, or carbidize the organometallic precursor at and beneath a surface of the refractory filament to form an interface coating include a metal or semi-metal oxide, metal or semi-metal nitride, metal or semi-metal carbide, metal or semi-metal oxynitride, metal or semi-metal carbonitride, metal or semi metal oxycarbide, or a combination thereof that surrounds the surface of the refractory filament.

12. The method of claim 11, wherein the supercritical fluid used to carry the organometallic precursor to the refractory filament is selected from carbon dioxide, methane, ethane, propane, ethylene, propylene, methanol, ethanol, acetone, ammonia, water, or nitrous oxide.

13. The method of claim 11, wherein:
the organometallic precursor is a metal or semi-metal alkoxide, a metal halide, a metal or semi-metal alkyammonium, a metal or semi-metal carborane, a metal or semi-metal organosilane, a metal or semi-metal organosiloxane, or a combination thereof; and
the atmospheric conditions include elevated levels of oxygen, halogen, nitrogen, ammonium, vacuum pressure from about 0.01 psi to about 100 psi, or a combination thereof.

14. The method of claim 13, wherein the metal or semi-metal of the organometallic precursor includes silicon, hafnium, tantalum, zirconium, titanium, tungsten, molybdenum, niobium, rhenium, lanthanides, or a combination thereof.

15. The method of claim 11, wherein the metal or semi-metal oxide, metal or semi-metal nitride, metal or semi-metal carbide, metal or semi-metal oxynitride, metal or semi-metal carbonitride, metal or semi metal oxycarbide, or a combination thereof that is formed is also present beneath the surface of the refractory filament at from greater than 0% up to 20% of a distance based on an x-y cross-sectional diameter of the refractory filament.

16. The method of claim 11, further comprising assembling the refractory filaments having metal or semi-metal oxide, metal or semi-metal nitride, metal or semi-metal carbide, metal or semi-metal oxynitride, metal or semi-metal carbonitride, metal or semi metal oxycarbide, or a combination thereof surrounding the surface of the refractory filaments to form tow, broadgood, or both.

17. The method of claim 16, wherein the broadgood is composited with and at least partially encapsulated with a ceramic material or preceramic polymer to form a ceramic matrix composite.

18. The method of claim 17, wherein the ceramic material is selected from carbon, silicon carbide, alumina, mullite, silicon nitride, aluminum phosphate, barium aluminum silicate, preceramic polymers, or a combination thereof.
